(19) United States
(12) Patent Application Publication
(10) Pub. No.: US 2024/0406326 A1
(43) Pub. Date: Dec. 5, 2024

(54) IMAGE READING DEVICE, IMAGE FORMING APPARATUS, NON-TRANSITORY COMPUTER READABLE MEDIUM STORING IMAGE READING PROGRAM, AND IMAGE READING METHOD

(71) Applicant: FUJIFILM Business Innovation Corp., Tokyo (JP)

(72) Inventor: Tomoki KINOSHITA, Kanagawa (JP)

(73) Assignee: FUJIFILM Business Innovation Corp., Tokyo (JP)

(21) Appl. No.: 18/512,035

(22) Filed: Nov. 17, 2023

(30) Foreign Application Priority Data
Jun. 5, 2023 (JP) 2023-092606

(51) Int. Cl. H04N 1/00

(52) U.S. Cl. CPC H04N 1/00779; H04N 1/00702

(57) ABSTRACT

An image reading device includes a transport section that transports a recording medium; a reading section that reads an image formed on the recording medium transported by the transport section, and a processor configured to set a transport speed of the recording medium by the transport section based on a transport state of the recording medium transported by the transport section.

### CROSS-REFERENCE TO RELATED APPLICATIONS

This application is based on and claims priority under 35 USC 119 from Japanese Patent Application No. 2023-092606 filed Jun. 5, 2023.

### BACKGROUND

### (i) Technical Field

The present invention relates to an image reading device, an image forming apparatus, a non-transitory computer readable medium storing an image reading program, and an image reading method.

### (ii) Related Art

JP2016-1795A discloses a configuration in which a specifying section and a transport control section are provided, the specifying section specifies a skew amount of a document based on a read image of the document obtained in a manner that an image reading unit reads the document while transporting the document by a transport unit, and the transport control section controls the transport unit to suppress transport of the document, based on the skew amount specified by the specifying section and a threshold value set in advance.

JP2022-35031A discloses a configuration in which two inclination sensors are provided in the middle of a document transport path in order to detect an inclination degree of a document transported along the document transport path.

### SUMMARY

In an image reading device, a recording medium as a reading target is transported, and a user may perform an operation on the recording medium according to a position shift or an inclination of the transported recording medium.

Here, in a case where a transport speed of the transported recording medium is low, the operability of the operation performed by the user on the recording medium is improved. On the other hand, in a case where the transport speed of the transported recording medium is low, the efficiency of reading an image formed on the recording medium is reduced.

Aspects of non-limiting embodiments of the present disclosure relate to an image reading device, an image forming apparatus, a non-transitory computer readable medium storing an image reading program, and an image reading method that improve operability of an operation performed by a user on a transported recording medium while suppressing a decrease in efficiency of reading an image formed on the recording medium, as compared with a configuration in which a transport speed of a transported recording medium does not change.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image reading device including a transport section that transports a recording medium; a reading section that reads an image formed on the recording medium transported by the transport section, and a processor configured to set a transport speed of the recording medium by the transport section based on a transport state of the recording medium transported by the transport section.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIG. 2 is a diagram illustrating an example of a hardware configuration of a control unit;

FIG. 3 is a diagram illustrating an image forming unit;

FIG. 4 is a diagram illustrating an image reading unit as viewed from the top;

FIGS. 5A to 5C are diagrams illustrating an operation of a user in a case where the image reading unit reads an image;

FIGS. 6A and 6B are diagrams illustrating setting of a transport speed of paper by a CPU;

(A) of FIG. 7 to (D) of FIG. 7 are diagrams illustrating an example of a flow of processing for transporting paper;

FIGS. 8A and 8B are diagrams illustrating an example of a notification performed via a notification unit; and

FIG. 9 is a flowchart illustrating a series of flow of processing.

### DETAILED DESCRIPTION

Hereinafter, an exemplary embodiment of the present invention will be described with reference to the accompanying drawings.

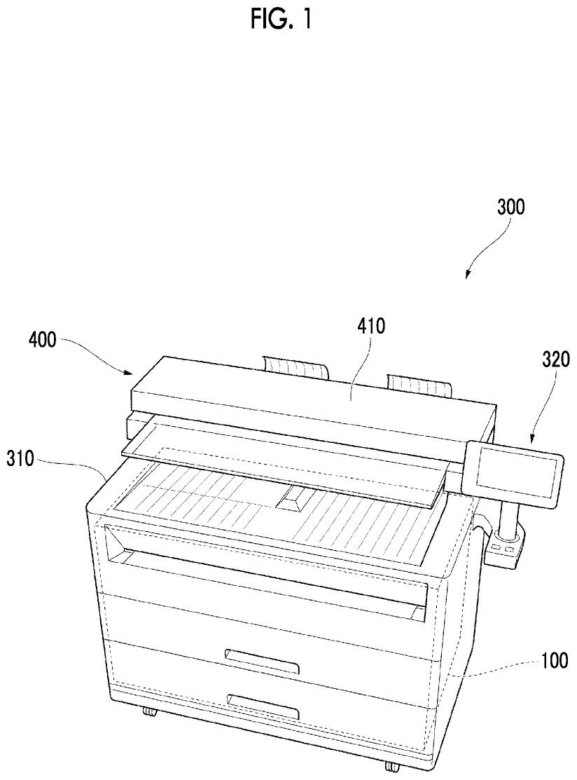

FIG. 1 is a diagram showing an image forming apparatus 300 according to the present exemplary embodiment.

In the present exemplary embodiment, an image forming unit 100 that forms an image on paper which is an example of a recording medium is provided on a lower side of the image forming apparatus 300.

The image forming unit 100 which is an example of an image forming section forms an image on paper based on image data obtained by reading of an image reading device 400 or image data transmitted to the image forming apparatus 300 from an outside of the image forming apparatus 300.

The image reading device 400 that reads an image formed on paper which is an example of a recording medium is provided on an upper side of the image forming apparatus 300. In other words, the image reading device 400 that reads a document on which an image is formed is provided on the upper side.

The image reading device 400 is provided with an image reading unit 410 in which a line sensor or the like is provided.

In the present exemplary embodiment, an image formed on paper is read in a process in which the paper as a document passes below the image reading unit 410 toward the back side in the drawing.

More specifically, in the present exemplary embodiment, the image formed on the paper is read in a process in which paper as a document passes between a device body 310 located below the image reading unit 410 and the image reading unit 410.

The image forming apparatus 300 in the present exemplary embodiment is further provided with a notification unit 320 for notifying the user of information. The notification unit 320 in the present exemplary embodiment is configured by a touch panel type display device.

In the present exemplary embodiment, the notification unit 320 may also receive information input to the image forming apparatus 300 by the user. The notification unit 320 also has a function of receiving information from the user.

In the present exemplary embodiment, a case where the user is notified of information by an image displayed on the notification unit 320 will be described as an example. A speaker may be installed and a sound output from the speaker may be used to notify the user of the information.

In the present exemplary embodiment, a control unit 240 (not illustrated in FIG. 1) that controls each unit of the image forming apparatus 300 is further provided in the image forming apparatus 300.

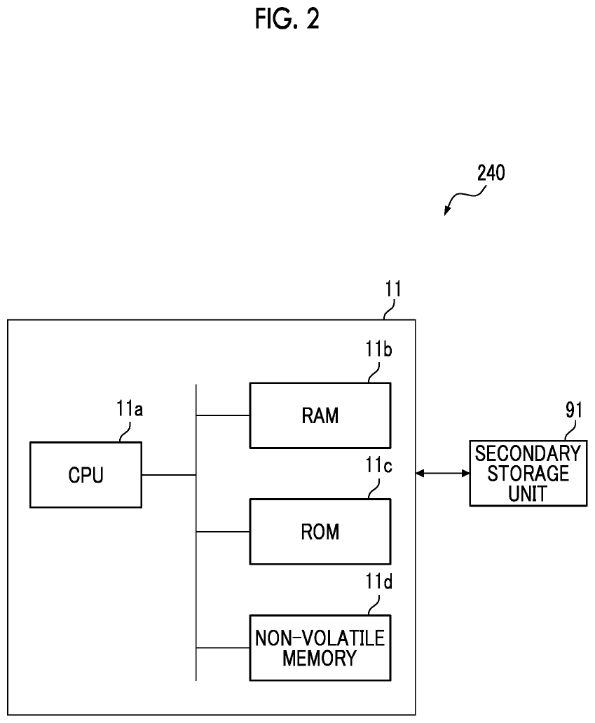

FIG. 2 is a diagram illustrating an example of a hardware configuration of the control unit 240. The control unit 240 is realized by a computer.

The control unit 240 includes an arithmetic processing unit 11 that executes a digital arithmetic process according to a program, and a secondary storage unit 91 that stores information.

The secondary storage unit 91 is realized, for example, by a known information storage device such as a hard disk drive (HDD), a semiconductor memory, or a magnetic tape.

The arithmetic processing unit 11 is provided with a CPU 1la as an example of a processor.

In addition, the arithmetic processing unit 11 is provided with a RAM 11b used as a working memory or the like of the CPU 1la and a ROM 11c in which programs or the like executed by the CPU 11a are stored.

Further, the arithmetic processing unit 11 is provided with a non-volatile memory 11d that is configured to be rewritable and can hold data even in a case in which power supply is interrupted.

The non-volatile memory 11d is configured by, for example, an SRAM or a flash memory that is backed up by a battery. The secondary storage unit 91 stores various types of information such as a program executed by the arithmetic processing unit 11.

In the present exemplary embodiment, the arithmetic processing unit 11 reads the program stored in the ROM 11c or the secondary storage unit 91, so that various processes are executed by the image forming apparatus 300.

Here, the program executed by the CPU 1la may be provided to the image forming apparatus 300 in a state of being stored in a computer-readable recording medium such as a magnetic recording medium (such as a magnetic tape or a magnetic disk), an optical recording medium (such as an optical disk), a magneto-optical recording medium, or a semiconductor memory. The program executed by the CPU 1la may be provided to the image forming apparatus 300 by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

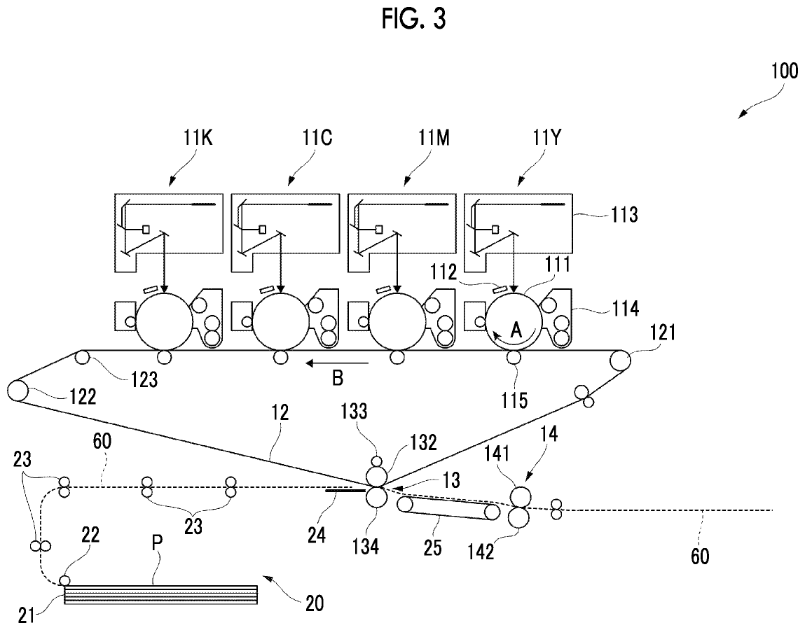

FIG. 3 is a diagram illustrating the image forming unit 100.

The image forming unit 100 illustrated in FIG. 3 is an example, and the device configuration of the image forming unit 100 is not limited to one illustrated in FIG. 3. The image forming unit 100 illustrated in FIG. 3 is an image forming unit that forms an image by using a so-called electrophotographic method. The image forming unit 100 may be, for example, an image forming unit that forms an image by using an inkjet method.

Further, the image forming unit 100 may be an image forming unit that forms an image by using a method other than the electrophotographic method and the inkjet method.

The image forming unit 100 is provided with an image forming unit 11 (11Y, 11M, 11C, and 11K), an intermediate transfer belt 12, a secondary transfer unit 13, and a fixer 14.

In the present exemplary embodiment, four image forming units 11Y, 11M, 11C, and 11K corresponding to four colors of toners including yellow (Y), magenta (M), cyan (C), and black (K) respectively are provided as the image forming unit 11.

The four image forming units 11Y, 11M, 11C, and 11K are arranged in a moving direction of the intermediate transfer belt 12 and form a toner image through an electrophotographic method.

Each of the four image forming units 11Y, 11M, 11C, and 11K is provided with a photoconductor drum 111, a charging unit 112, an exposure unit 113, a developing unit 114, and a primary transfer unit 115.

Each of the four image forming units 11Y, 11M, 11C, and 11K forms a toner image of any color of YMCK and transfers the formed toner image to the intermediate transfer belt 12. Accordingly, the toner image in which the toner images of respective colors including YMCK overlap each other is formed on the intermediate transfer belt 12.

The photoconductor drum 111 rotates in an arrow A direction in the drawing at a speed determined in advance. The charging unit 112 charges the peripheral surface of the photoconductor drum 111 at a potential determined in advance. The exposure unit 113 irradiates the charged peripheral surface of the photoconductor drum 111 with light and forms an electrostatic latent image on the peripheral surface of the photoconductor drum 111.

The developing unit 114 forms a toner image by attaching a toner to the electrostatic latent image formed on the peripheral surface of the photoconductor drum 111. The primary transfer unit 115 transfers the toner image formed on the peripheral surface of the photoconductor drum 111 onto the intermediate transfer belt 12.

A voltage having a polarity opposite to a charging polarity of a toner is applied to the primary transfer unit 115. Thus, the toner image formed on the peripheral surface of the photoconductor drum 111 is sequentially electrostatically attracted onto the intermediate transfer belt 12. As a result, one overlapping color toner image is formed on the intermediate transfer belt 12. In a case where a black and white image is formed, a black toner image is formed on the intermediate transfer belt 12.

The intermediate transfer belt 12 is supported by a plurality of roll-like members. The intermediate transfer belt 12 is a belt-like member that circulates and moves in an arrow B direction in the drawing.

In the present exemplary embodiment, as a plurality of roll-like members, a drive roll 121 that is driven by a motor (not illustrated) to drive the intermediate transfer belt 12, a tension roll 122 that applies tension to the intermediate transfer belt 12, an idle roll 123 that supports the intermediate transfer belt 12, and a backup roll 132 are provided.

In the present exemplary embodiment, a paper transport unit 20 is further provided.

The paper transport unit 20 is provided with a paper accommodation unit 21 that accommodates paper P and a pickup roll 22 that takes out and transports the paper P accommodated in the paper accommodation unit 21.

In addition, the paper transport unit 20 is provided with a transport roll 23 that transports the paper P taken out by the pickup roll 22 along a paper transport path 60 and a guiding unit 24 that guides the paper P transported by the transport roll 23 to the secondary transfer unit 13. In addition, the paper transport unit 20 is provided with a transport belt 25 that transports the paper P after the secondary transfer to the fixer 14.

In the present exemplary embodiment, a configuration in which rectangular paper is accommodated in the paper accommodation unit 21 has been made, but the present exemplary embodiment is not limited to this. Roll-like paper may be installed in the paper accommodation unit 21, and paper may be supplied to the secondary transfer unit 13 by sequentially feeding out the paper from the roll-like paper.

In this case, for example, by installing a cutting device on the downstream side of the fixer 14 and cutting the paper with this cutting device, rectangular paper on which an image is formed is obtained.

The secondary transfer unit 13 is provided with a secondary transfer roller 134 that is disposed to be in contact with the outer surface of the intermediate transfer belt 12 and the backup roller 132 that is disposed on an inner side of the intermediate transfer belt 12 and forms an electrode facing the secondary transfer roller 134.

In addition, in the present exemplary embodiment, a power supplying roller 133 made of a metal, which applies a secondary transfer bias to the backup roller 132, is provided.

In the secondary transfer unit 13, the toner image formed on the intermediate transfer belt 12 is transferred onto the transported paper P.

The fixer 14 is disposed on a downstream side of the secondary transfer unit 13 in a transport direction of the paper P. The fixer 14 is provided with a fixing roll 141 having a heating source (not illustrated) and a pressing roll 142 that is provided to face the fixing roll 141 and presses the fixing roll.

In the present exemplary embodiment, the paper P that has passed through the secondary transfer unit 13 is transported between the fixing roll 141 and the pressing roll 142. In a case where the paper P passes between the fixing roll 141 and the pressing roll 142, the toner image unfixed on the paper P is fixed on the paper P. As a result, an image consisting of the toner image is formed on the paper P.

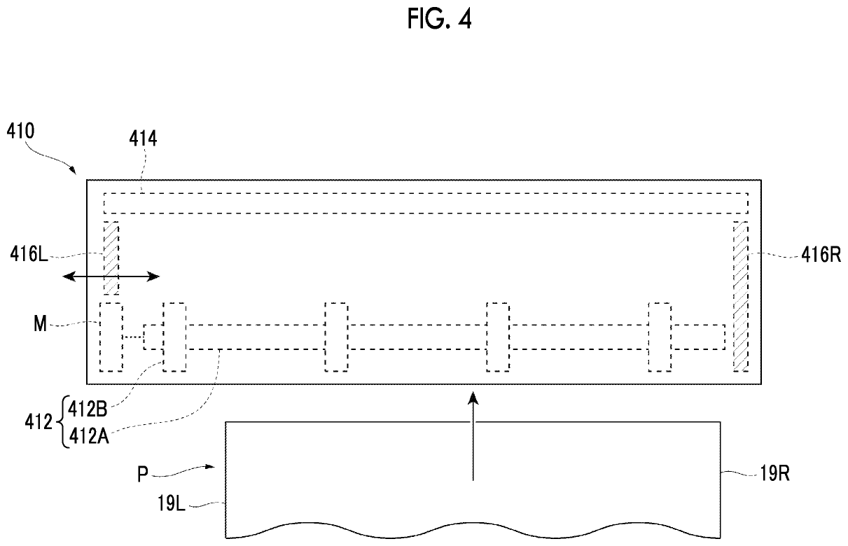

FIG. 4 is a diagram illustrating the image reading unit 410 illustrated in FIG. 1 as viewed from the top.

In the present exemplary embodiment, a transport roll 412 is provided in the image reading unit 410 as an example of a transport section that transports paper P, which is an example of a recording medium and an example of a document.

The transport roll 412 is configured by a rotation shaft 412A rotated by a motor M and a cylindrical elastic body 412B provided around the rotation shaft 412A. In the present invention, the rotating elastic body 412B pushes the paper P upward in the drawing, thereby transporting the paper P.

A plurality of elastic bodies 412B are provided and are disposed in a state of being arranged in an axial direction of the rotation shaft 412A.

Further, a line sensor 414 that reads an image formed on the paper P transported by the transport roll 412 is provided in the image reading unit 410.

The line sensor 414 as an example of a reading section is provided in a form of extending in a direction perpendicular to a transport direction of the paper P transported by the transport roll 412. In other words, the line sensor 414 is provided in a form of extending in a direction intersecting the transport direction of the paper P transported by the transport roll 412.

The line sensor 414 is provided with a plurality of light receiving elements (not illustrated). The plurality of light receiving elements are arranged along an extension direction of the line sensor 414. In the present exemplary embodiment, read data obtained by reading an image on the paper P is generated based on a signal output from each of the light receiving elements.

The image reading unit 410 is further provided with a right side guide 416R against which a side 19R of the paper P on the right side in the drawing (referred to as a “right side 19R” below) is pressed, and which guides the right side 19R.

In the present exemplary embodiment, the paper P is pressed against the right side guide 416R as an example of a pressing target portion by an operation of the user on the paper P, and the paper P is transported to the downstream side while being guided by the right side guide 416R.

In the present exemplary embodiment, a left side guide 416L that comes into contact with a side 19L of the paper P on the left side in the drawing (referred to as a “left side 19L” below) is further provided. The left side guide 416L is movable in a direction perpendicular to the transport direction of the paper P.

In the present exemplary embodiment, in a case where the paper P is transported by the transport roll 412, the user touches the paper P and performs an operation on the paper P. In other words, the user touches the paper P and applies a load to the paper P.

More specifically, the user moves the transported paper P to the right side so that the right side 19R of the paper P moves while being guided by the right side guide 416R.

In the present exemplary embodiment, in a case where the paper P is transported, the user performs an operation on the paper P so that the paper P moves along a predetermined path.

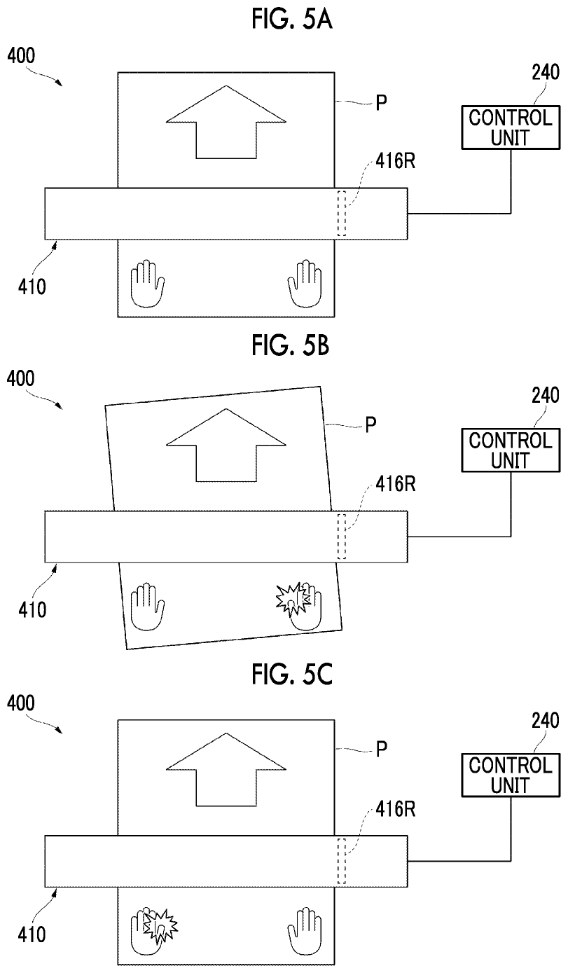

FIGS. 5A to 5C are diagrams illustrating the operation of the user in a case where the image reading unit 410 reads an image.

The image reading device 400 in the present exemplary embodiment may read wide and long paper P. In a case where the wide and long paper P is read, the paper P is transported while an operation on the paper P is performed by the hand of the user as described above and as illustrated in FIG. 5A.

Here, it is assumed that, while the paper P is transported, for example, as illustrated in FIG. 5B, the paper Pis inclined and tries to move to the left, for example. In this case, the user applies a load to the paper P with his/her right or left hand so that the paper P is directed to the right side guide 416R side.

As a result, as illustrated in FIG. 5C, the paper P approaches the right side guide 416R side and turns into a straight state. Then, the transport of the paper P in this state is continued.

In the present exemplary embodiment, in order to facilitate this operation by the user, the transport speed of the paper P by the transport roll 412 is changed according to a transport state of the paper P transported by the transport roll 412 (see FIG. 4).

In the present exemplary embodiment, the CPU 11a (see FIG. 2) as an example of a processor, which is provided in the control unit 240, sets the transport speed of the paper P by the transport roll 412 based on a transport state of the paper P transported by the transport roll 412 which is an example of the transport section.

In the present exemplary embodiment, the motor M (see FIG. 4) is driven in a form corresponding to the set transport speed.

As a result, as will be described later, the transport speed of the paper P is reduced, and the user may more easily perform the operation on the paper P.

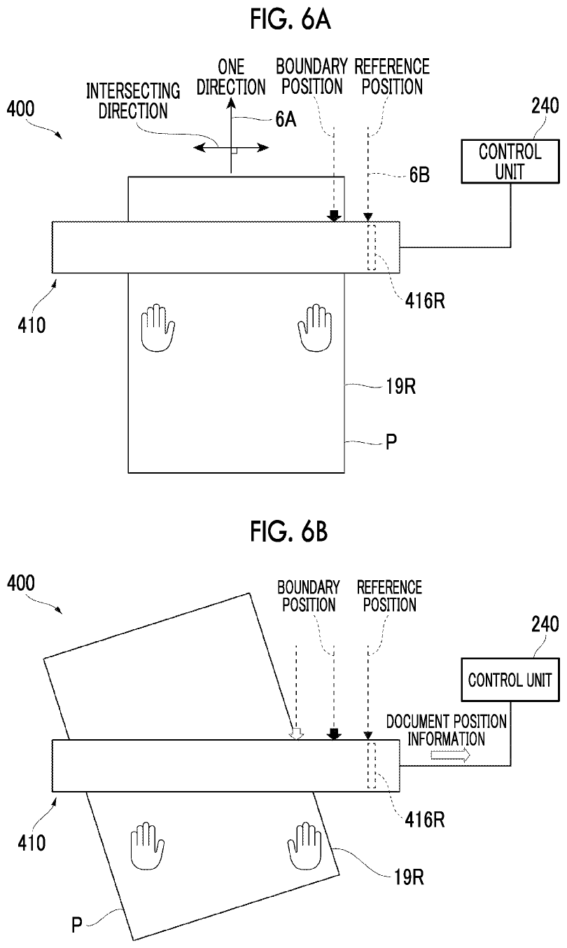

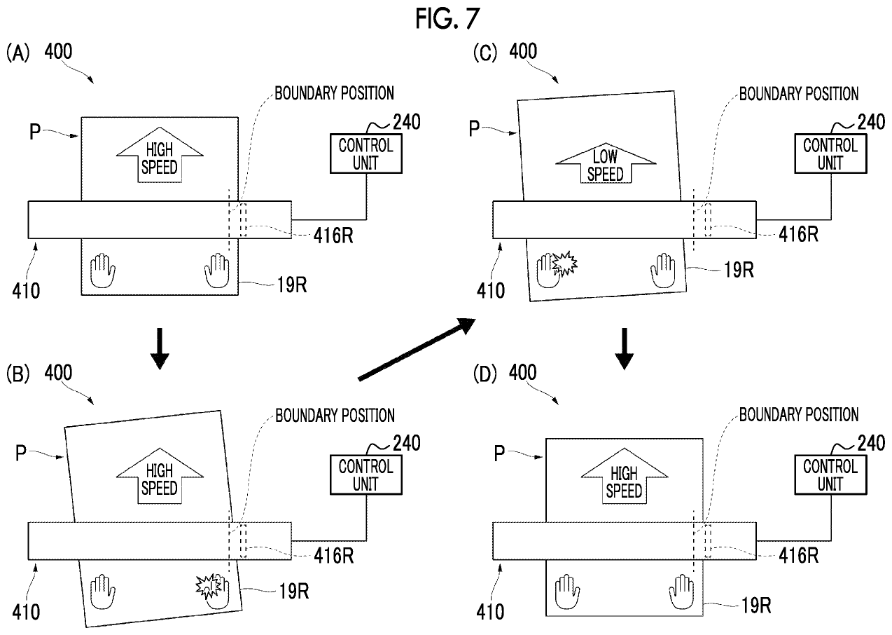

FIGS. 6A and 6B are diagrams illustrating setting of the transport speed of the paper P by the CPU 11a.

In the present exemplary embodiment, the CPU 11a as an example of the processor sets the transport speed based on a state regarding a position of the paper P transported by the transport roll 412 (see FIG. 4).

In the present exemplary embodiment, the transport roll 412 (not illustrated in FIGS. 6A and 6B) transports the paper P in a direction indicated by an arrow 6A, which is one direction, as illustrated in FIG. 6A.

The CPU 11a sets the transport speed based on a state regarding a position of the paper P transported by the transport roll 412 in a direction intersecting the one direction.

Specifically, in the example illustrated in FIGS. 6A and 6B, the CPU 11a sets the transport speed based on a state regarding the position of the paper P in the right-left direction in the drawing.

In the present exemplary embodiment, in a case where the position of the paper P in the intersecting direction is a specific position, the CPU 11a sets the transport speed of the paper P by the transport roll 412 to be reduced as compared with a case where the position is not the specific position.

More specifically, in a case where the position of the paper P in the intersecting direction is located on the left side of a predetermined boundary position in the drawing as illustrated in FIG. 6B, and exceeds the boundary position, the CPU 11a sets the transport speed of the paper P by the transport roll 412 to be reduced.

More specifically, in a case where the position of the paper P on the right side 19R in the intersecting direction exceeds a predetermined boundary position, the CPU 11a sets the transport speed of the paper P by the transport roll 412 to be reduced.

In the present exemplary embodiment, the position of the right side 19R of the paper P is specified based on an output from the line sensor 414 (see FIG. 4).

In the present exemplary embodiment, among a plurality of light receiving elements provided in the line sensor 414, a signal output from the light receiving element located at the facing position of the paper P is different from a signal output from the light receiving element located at a position away from the facing position of the paper P.

In the present exemplary embodiment, the position of the right side 19R of the paper P is specified based on the difference between the signals output from the plurality of respective light receiving elements.

The specification of the position of the right side 19R of the paper P is not limited to being performed based on the output from the line sensor 414. A dedicated sensor for specifying the position of the right side 19R of the paper P may be separately provided, and the position of the right side 19R may be specified by using the dedicated sensor.

In the present exemplary embodiment, an installation position of the right side guide 416R is set as a predetermined reference position. Further, in the present exemplary embodiment, a distance from the reference position to the boundary position is set as a predetermined threshold value.

In the present exemplary embodiment, in a case where the position of the paper P is a position where a predetermined distance from the reference position to the paper P is greater than a predetermined threshold value, the transport speed of the paper P is set to be reduced as compared with a case where the position of the paper P is a position where the distance is not greater than the threshold value.

More specifically, in the present exemplary embodiment, in a case where the position of the right side 19R of the paper P is a position where a distance from the predetermined reference position to the right side 19R is greater than a predetermined threshold value, the transport speed of the paper P is set to be reduced as compared with a case where the position of the right side 19R of the paper P is a position where the distance is not greater than the threshold value.

In the present exemplary embodiment, the CPU 11a specifies a distance from the position of the right side guide 416R, which is the reference position, to the right side 19R of the paper P, based on the output from the line sensor 414.

In a case where the specified distance is greater than a predetermined threshold value, the CPU 11a sets the transport speed of the paper P to be reduced as compared with a case where the specified distance is smaller than the threshold value.

In the present exemplary embodiment, a position indicated by the reference sign 6B in FIG. 6A is the reference position.

FIG. 6A illustrates a case where the distance from the reference position to the right side 19R of the paper P is smaller than a predetermined threshold value. In other words, FIG. 6A illustrates a case where the position of the right side 19R of the paper P is on the right side of the boundary position.

In this case, the CPU 11a does not set the transport speed of the paper P to be reduced.

On the other hand, FIG. 6B illustrates a case where the distance from the reference position to the right side 19R of the paper P is greater than the predetermined threshold value. In other words, FIG. 6B illustrates a case where the position of the right side 19R of the paper P is on the left side of the boundary position.

In this case, the CPU 11a sets the transport speed of the paper P to be reduced.

In a case where the transport speed of the paper P is set to be reduced, a rotation speed of the motor M (see FIG. 4) is decreased, and the transport speed of the paper P is decreased accordingly.

In a case where the transport speed of the paper P is decreased as in the present exemplary embodiment, it becomes easier for the user to perform an operation of moving the paper P to the right side guide 416R side as a reference.

Further, in a case where the transport speed of the paper P is decreased as in the present exemplary embodiment, it becomes easier for the user to perform an operation of straightening the paper P. In other words, in a case where the transport speed of the paper P is decreased, it becomes easy for the user to perform an operation of changing the posture of the paper P.

In a case where it is difficult to perform an operation of moving the paper P or an operation of changing the posture of the paper P, the quality of the read image obtained by reading an image on the paper P may be deteriorated.

In addition, in a case where it is difficult to perform the operation of moving the paper P or the operation of changing the posture of the paper P, the inclined paper P may be pressed against the left side guide 416L (see FIG. 4), and thus the paper P may be damaged.

On the other hand, in a case where it is easy to perform the operation of moving the paper P or the operation of changing the posture of the paper P as in the present exemplary embodiment, this problem is less likely to occur.

In order to decrease the transport speed of the paper P, the transport speed of the paper P may be set to zero, and the transport of the paper P may be temporarily stopped.

However, for example, more preferably, in order to decrease the transport speed of the paper P, even in a case where the transport speed of the paper P is not set to zero and the transport speed of the paper P is decreased, the transport of the paper P is continued at a low speed.

In a case where the transport speed of the paper P is set to zero and the transport of the paper P is temporarily stopped, an image obtained by reading before the transport of the paper P is stopped may be discontinuous with an image obtained by reading after the transport of the paper Pis restarted.

On the other hand, in a case where the transport of the paper P is continued without being stopped, it is possible to avoid an occurrence of this problem.

In a case where the position of the paper P in the intersecting direction is no longer the specific position, the CPU 11a sets the transport speed to be increased.

Specifically, in a case where the position of the paper P in the intersecting direction is on the right side of the boundary position, the CPU 11a sets the transport speed to be increased.

More specifically, in a case where the position of the right side 19R of the paper P in the intersecting direction is on the right side of the boundary position, the CPU 11a sets the transport speed to return to an original transport speed.

In the present exemplary embodiment, as described above, in a case where the transport state of the paper P is in a specific state, for example, the paper P is located on the left side of the boundary position, the CPU 11a sets the transport speed to be changed.

In addition, in a case where the transport state of the paper P is no longer in this specific state, the CPU 11a sets the transport speed to return to the original transport speed.

In a case where setting of changing the transport speed is performed, the transport speed of the paper P remains low, and the efficiency of reading an image formed on the paper P is decreased. By returning the transport speed to the original transport speed, it is possible to suppress a decrease in the efficiency of reading the image.

(A) of FIG. 7 to (D) of FIG. 7 are diagrams illustrating an example of a flow of processing for transporting the paper P.

(A) of FIG. 7 illustrates a state of the paper P immediately after the transport is started. In this state, the paper P is along the right side guide 416R, and the paper P is in a straight state. Further, in this state, the right side 19R of the paper P is located on the right side of the boundary position.

Further, in this state, the transport speed of the paper P is set to a first transport speed, which is a high speed.

(B) of FIG. 7 illustrates a state in which, after the state illustrated in (A) of FIG. 7, the paper Pis inclined and the movement of the paper P is started in a direction away from the right side guide 416R.

Even in this state, the right side 19R of the paper P does not exceed the boundary position, and the transport speed of the paper P remains the first transport speed.

(C) of FIG. 7 illustrates a state after the right side 19R of the paper P exceeds the boundary position.

In this state, the CPU 11a sets the transport speed of the paper P to be reduced. As a result, the paper Pis transported at a second transport speed that is smaller than the first transport speed. In this state, the user easily performs the operation on the paper P.

(D) of FIG. 7 illustrates a state where the paper P is in a straight state by the operation of the user, and a state after the position of the right side 19R of the paper P is located on the right side of the boundary position.

In this state, the transport speed of the paper P is set to the first transport speed, and the transport speed of the paper P is the original transport speed that is a speed before the transport speed is reduced.

### Other Exemplary Embodiment

In the above description, the case where the transport speed of the paper P is set based on the position of the document has been described. However, the present exemplary embodiment is not limited to this, and the transport speed may be set based on the degree of the movement of the paper P.

In this case, the CPU 11a sets the transport speed, for example, based on the degree of the movement of the paper P transported by the transport roll 412 in the direction intersecting the one direction.

Here, the degree of the movement of the paper P may be specified, for example, based on the output from the line sensor 414, similarly to the above description.

In order to specify the degree of the movement of the paper P, for example, the position of the right side 19R of the paper P immediately after the transport of the paper P is started is set as the reference position.

After the reference position is specified, the degree of the movement of the paper Pis specified based on a distance between the position of the right side 19R of the transported paper P and the reference position.

In the above exemplary embodiment illustrated in FIGS. 6A to 7, the reference position is configured to be the installation position of the right side guide 416R and be fixed. In a case where the position of the right side 19R of the paper P is set as the reference position, the reference position is set for each sheet of paper P.

In a case where the transport speed is set based on the degree of the movement of the paper P, for example, in a case where an amount of the movement of the paper P in the intersecting direction is greater than a predetermined threshold value, the CPU 11a sets the transport speed to be reduced as compared with a case where the amount of the movement is not greater than the predetermined threshold value.

Thus, similarly to the above description, the user easily performs the operation on the paper P.

In a case where the transport speed is set based on the degree of the movement of the paper P, and in a case where the amount of the movement of the paper P in the intersecting direction is smaller than the predetermined threshold value, the CPU 11a sets the transport speed to be increased.

In other words, in a case where the amount of the movement of the paper P in the intersecting direction becomes smaller than the predetermined threshold value, the CPU 11a sets the transport speed to return to the original transport speed.

In other words, in a case where the amount of the movement of the paper P in the state where the amount of the movement is large becomes smaller than the predetermined threshold value, the CPU 11a sets the transport speed to return to the original transport speed.

### Other Exemplary Embodiment

In addition, the CPU 11a may set the transport speed based on a state regarding the inclination of the paper P transported by the transport roll 412.

Specifically, in this case, for example, in a case where the inclination of the paper P transported by the transport roll 412 is greater than a predetermined threshold value, the CPU lla sets the transport speed to be reduced as compared with a case where the inclination is smaller than the predetermined threshold value.

More specifically, for example, in a case where the inclination of the right side 19R of the paper P transported by the transport roll 412, the inclination being with respect to one direction, is greater than the predetermined threshold value, the CPU 11a sets the transport speed to be reduced as compared with a case where the inclination is smaller than the predetermined threshold value.

In order to specify the inclination of the paper P, for example, two sensors whose positions of the paper P in the transport direction are different from each other are provided. Using the two sensors, for example, the position of the right side 19R of the paper P is specified. As a result, the inclination of the right side 19R may be specified.

Similarly to the above description, in a case where the inclination of the paper P transported by the transport roll 412 is smaller than the predetermined threshold value, the CPU 11a sets the transport speed to be increased. In other words, in this case, the CPU 11a sets the transport speed to return to the original transport speed.

In other words, in a case where the magnitude of the inclination of the paper P in the state where the inclination is large becomes smaller than the predetermined threshold value, the CPU 11a sets the transport speed to return to the original transport speed.

### Notification Process

In the present exemplary embodiment, as described above, in a case where the transport state of the paper P transported by the transport roll 412 is in a specific state, the CPU 11a sets the transport speed to be changed. Specifically, the CPU 11a performs a setting of decreasing the transport speed and a setting of returning the transport speed to the original transport speed.

In the case of performing the setting for changing the transport speed as described above, for example, it is preferable to notify the user that the transport speed of the paper P is changed.

In the present exemplary embodiment, in a case where the CPU 11a performs the setting of changing the transport speed, the CPU 1la notifies the user that the transport speed of the paper P is changed.

Specifically, in a case where the CPU 11a performs the setting of changing the transport speed, the CPU 11a notifies the user that the transport speed of the paper P is changed, via the notification unit 320 (see FIG. 1).

As a result, in a case where the transport speed of the paper P is changed, the user knows that the transport speed of the paper P is changed, via the notification unit 320.

For example, it is preferable that this notification is performed before the transport speed of the paper P is actually changed.

Specifically, for example, it is preferable that the notification is performed before the transport speed of the paper P is actually reduced, and it is preferable that the notification is performed before the transport speed of the paper P actually returns to the original transport speed.

Further, the notification may be given only in either a case where the transport speed of the paper P is reduced or a case where the transport speed of the paper P returns to the original transport speed.

Further, the notification is not limited to the notification by displaying information on the notification unit 320, and may be performed by sound through a speaker.

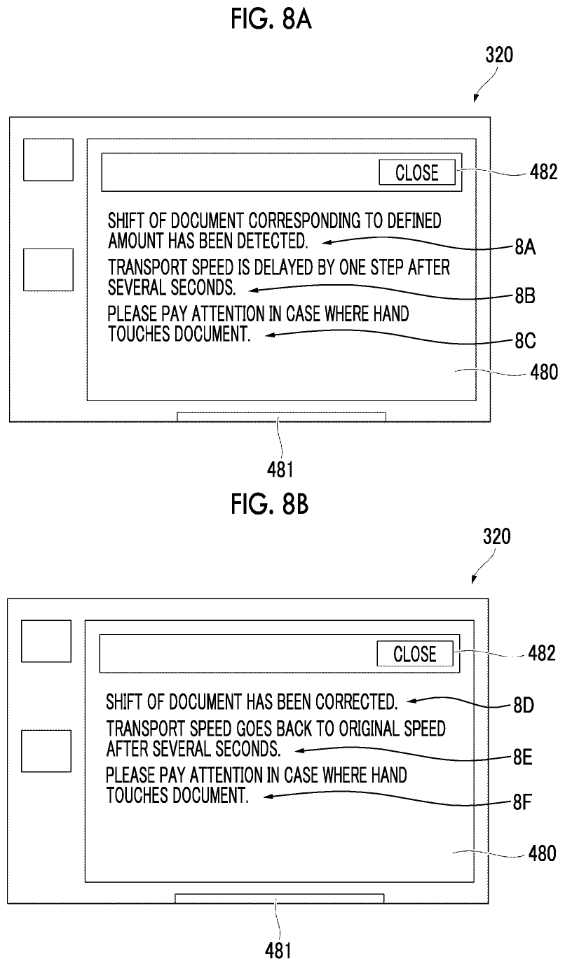

FIGS. 8A and 8B are diagrams illustrating an example of the notification performed via the notification unit 320.

FIG. 8A illustrates an example of the notification in a case where the transport speed of the paper P is set to be reduced.

In this notification illustrated in FIG. 8A, as indicated by the reference sign 8A in FIGS. 8A and 8B, a notification indicating that the shift of the document is detected is performed. Further, in this notification illustrated in FIG. 8A, as indicated by the reference sign 8B, a notification that the transport speed of the paper P is reduced by one step is performed after several seconds. Further, in this notification illustrated in FIG. 8A, as indicated by the reference sign 8C, a notification for calling attention is performed to the user who touches the document.

The user recognizes that the transport speed of the paper P is reduced by referring to this notification.

Further, in this display example, a light source 481 configured by an LED or the like is provided at a lower portion of a screen 480, and the light source 481 is configured to light or blink.

Further, an operation button 482 touched in a case where the user closes the screen 480 displayed on the notification unit 320 is displayed on the notification unit 320.

In the present exemplary embodiment, the screen 480 displayed on the notification unit 320 is automatically hidden after a lapse of a predetermined time.

FIG. 8B illustrates an example of the notification in a case where the transport speed of the paper P is set to return to the original transport speed.

In this notification illustrated in FIG. 8B, as indicated by the reference sign 8D, a notification indicating that the shift of the document has been corrected is performed. Further, in this notification illustrated in FIG. 8B, as indicated by the reference sign 8E, a notification that the transport speed of the document returns to the original transport speed is performed after several seconds. Further, in this notification illustrated in FIG. 8B, as indicated by the reference sign 8F, a notification for calling attention is performed to the user who touches the document.

The user recognizes that the transport speed of the paper P returns to the original transport speed by referring to this notification.

Further, in this display example, similarly to the above description, the light source 481 configured by an LED or the like is provided at a lower portion of the screen 480, and the light source 481 is configured to light or blink.

Further, similarly to the above description, in the notification unit 320 illustrated in FIG. 8B, the operation button 482 touched in a case where the user closes the screen 480 displayed on the notification unit 320 is also displayed on the notification unit 320.

Further, in the present exemplary embodiment, the screen 480 displayed on the notification unit 320 illustrated in FIG. 8B is automatically hidden after a lapse of a predetermined time.

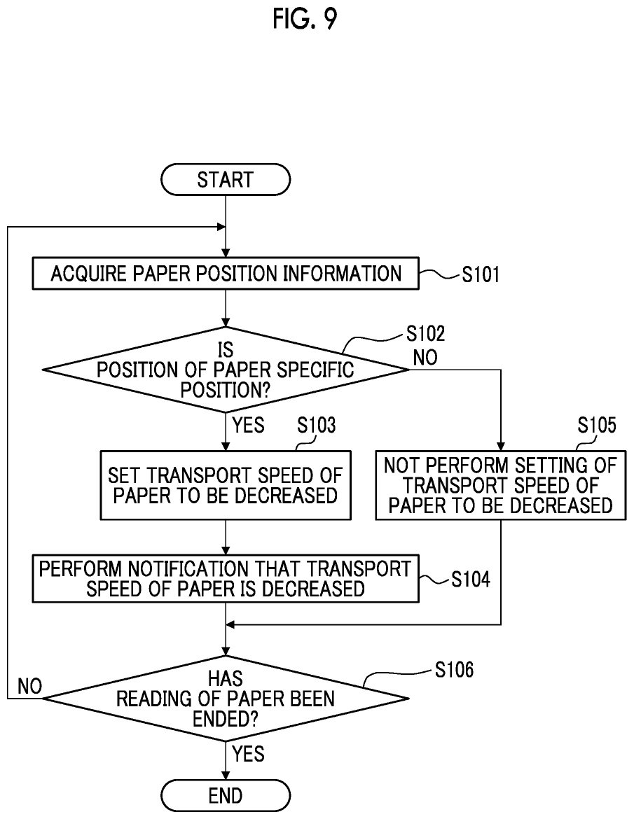

FIG. 9 is a flowchart illustrating a series of flow of processing described above. In FIG. 9, the processing flow illustrated in FIGS. 6 and 7 will be described as an example.

In the present exemplary embodiment, in a case where transport of paper P is started, the CPU 11a acquires position information of the paper P based on the output from the line sensor 414 (Step S101). Specifically, the CPU 11a acquires information regarding the position of the right side 19R of the paper P.

Then, the CPU 11a determines whether or not the position of the paper P is a specific position based on the acquired position information (Step S102).

In a case where the CPU 11a determines that the position of the paper P is the specific position described above, the CPU 11a sets the transport speed of the paper P to be decreased (Step S103). In other words, in a case where the CPU 11a determines that the position of the paper P is the specific position described above, the CPU 11a sets the transport speed of the paper P to be reduced. Here, “decreasing the transport speed of the paper P” is synonymous with “reducing the transport speed of the paper P”.

Specifically, in the present exemplary embodiment, in a case where the CPU 11a determines that the position of the paper P is the specific position described above, the CPU 11a sets the transport speed of the paper P to be a second transport speed smaller than a first transport speed from the first transport speed which is an initial value.

In addition, the CPU 1la notifies the user that the transport speed of the paper P is decreased, via the notification unit 320 (Step S104).

On the other hand, in a case where the CPU 11a does not determine in Step S102 that the position of the paper P is the specific position described above, the CPU 11a does not set the transport speed of the paper P to be decreased (Step S105).

In Step S105, the CPU 11a determines whether the transport speed of the paper P, which is set at a time in which Step S105 is executed, is the first transport speed which is the above-described initial value.

In a case where the CPU 11a determines that the transport speed of the paper P, which is set at the time at which Step S105 is executed, is the first transport speed, the CPU 11a causes the transport of the paper P to be continued as it is.

On the other hand, in a case where the transport speed of the paper P, which is set at the time in which Step S105 is executed, is not the first transport speed but the second transport speed, the CPU 11a sets the transport speed of the paper P to be the first transport speed. In other words, the CPU 11a sets the transport speed of the paper P to return to the original transport speed.

In a case where the CPU 1la sets the transport speed of the paper P to return to the original transport speed, the CPU 11a notifies the user that the transport speed of the paper P returns to the original transport speed, via the notification unit 320.

In a case where it is not determined in Step S102 that the position of the paper P is the specific position and it is determined in Step S105 that the transport speed of the paper P is the second transport speed, this means that the paper P that has been transported at a small transport speed and been located at the specific position has returned to a position other than the specific position.

In this case, as described above, the CPU 11a sets the transport speed of the paper P to be the first transport speed, which is a high speed. Further, in this case, the CPU 11a performs a notification that the transport speed of the paper P returns to the original transport speed, following this setting.

After the process of Step S104 and after the process of Step S105, the CPU 11a determines whether or not the reading of the paper P is ended (Step S106). In a case where the CPU 11a determines that the reading of the paper Pis ended, the CPU 11a ends the processing.

On the other hand, in a case where the CPU 11a determines in Step S106 that the reading of the paper P has not been ended, the CPU 11a performs the process in and after Step S101 again.

In the present exemplary embodiment, in a case where the paper P at the specific position is located at a position other than the specific position, it is determined in Step S102 above that the position of the paper P is not the specific position. Then, the process proceeds to the process of Step S105.

In this case, in Step S105, as described above, the CPU 11a sets the transport speed of the paper P to be the first transport speed. As a result, the transport speed of the paper P returns to the original transport speed.

### Others

In the above description, the case where two types of transport speeds, the first transport speed and the second transport speed, are set as the transport speeds has been described, but three or more types of transport speeds may be set as the transport speeds.

Three types or more transport speeds may be set such that the transport speed is gradually reduced in accordance with an increase in the amount of shift of the position of the transported paper P, the amount of the movement of the transported paper P, and the amount of inclination of the transported paper P.

Further, in the above description, by specifying the position of the right side 19R of the paper P, the amount of shift of the position of the paper P, the amount of the movement of the paper P, and the amount of the inclination of the paper P are specified. The present exemplary embodiment is not limited to this. The position of the left side 19L of the paper P may be specified, and the amount of shift of the position of the paper P, the amount of the movement of the paper P, and the amount of the inclination of the paper P may be specified based on the result of specifying the position of the left side 19L.

### Supplementary Note

(((1)))

An image reading device comprising:
a transport section that transports a recording medium;
a reading section that reads an image formed on the recording medium transported by the transport section; and
a processor configured to:
   set a transport speed of the recording medium by the transport section based on a transport state of the recording medium transported by the transport section.
      (((2)))

The image reading device according to (((1))), wherein the processor is configured to:
set the transport speed based on a state regarding a position of the recording medium transported by the transport section.
   (((3)))

The image reading device according to (((2))),
wherein the transport section transports the recording medium in one direction, and the processor is configured to:
   set the transport speed based on a state regarding a position of the recording medium transported by the transport section in a direction intersecting the one direction.
      (((4)))

The image reading device according to (((3))), wherein the processor is configured to:
in a case where the position of the recording medium in the intersecting direction is a specific position, set the transport speed to be reduced as compared with a case where the position is not the specific position.
   (((5))

The image reading device according to (((4))), wherein the processor is configured to:
in a case where the position of the recording medium in the intersecting direction is a position where a distance from a predetermined reference position to the recording medium is greater than a predetermined threshold value, set the transport speed to be reduced as compared with a case where the position of the recording medium in the intersecting direction is a position where the distance is not greater than the threshold value.
   (((6)))

The image reading device according to (((4))) or (((5))), wherein the processor is configured to:
in a case where the position of the recording medium in the intersecting direction is not the specific position, set the transport speed to be increased.
   (((7)))

The image reading device according to (((1))),
wherein the transport section transports the recording medium in one direction, and
the processor is configured to:
   set the transport speed based on a degree of a movement of the recording medium transported by the transport section in a direction intersecting the one direction.
      (((8)))

The image reading device according to (((7))), wherein the processor is configured to:
in a case where an amount of the movement of the recording medium in the intersecting direction is greater than a predetermined threshold value, set the transport speed to be reduced as compared with a case where the amount of the movement of the recording medium is not greater than the predetermined threshold value.
   (((9)))

The image reading device according to (((8))), wherein the processor is configured to:
in a case where the amount of the movement of the recording medium in the intersecting direction is smaller than the predetermined threshold value, set the transport speed to be increased.
   (((10)))

The image reading device according to (((1))), wherein the processor is configured to:
set the transport speed based on a state regarding an inclination of the recording medium transported by the transport section.
   (((11)))

The image reading device according to (((10))), wherein the processor is configured to:
in a case where the inclination of the recording medium transported by the transport section is greater than a predetermined threshold value, set the transport speed to be reduced as compared with a case where the inclination is smaller than the predetermined threshold value.
   (((12)))

The image reading device according to (((11))), wherein the processor is configured to:
in a case where the inclination of the recording medium transported by the transport section is smaller than the predetermined threshold value, set the transport speed to be increased.
   (((13)))

The image reading device according to (((1))), wherein the processor is configured to:
set the transport speed to be changed in a case where the transport state of the recording medium transported by the transport section is in a specific state; and
set the transport speed to return to an original transport speed in a case where the transport state of the recording medium is not in the specific state.
   (((14)))

The image reading device according to any one of (((1))) to (((13))), wherein the processor is configured to:
set the transport speed to be changed in a case where the transport state of the recording medium transported by the transport section is in a specific state; and
notify a user that the transport speed of the recording medium is changed, in a case where the transport speed is set to be changed.
   (((15)))

An image forming apparatus comprising:
an image reading device that reads an image formed on a recording medium; and
an image forming section that forms an image obtained by reading of the image reading device on the recording medium,
wherein the image reading device is configured by the image reading device according to any one of (((1))) to (((14))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device comprising:
a transport section that transports a recording medium;
a reading section that reads an image formed on the recording medium transported by the transport section; and
a processor configured to:
set a transport speed of the recording medium by the transport section based on a transport state of the recording medium transported by the transport section.

2. The image reading device according to claim 1, wherein the processor is configured to:
set the transport speed based on a state regarding a position of the recording medium transported by the transport section.

3. The image reading device according to claim 2,
wherein the transport section transports the recording medium in one direction, and
the processor is configured to:
set the transport speed based on a state regarding a position of the recording medium transported by the transport section in a direction intersecting the one direction.

4. The image reading device according to claim 3, wherein the processor is configured to:
in a case where the position of the recording medium in the intersecting direction is a specific position, set the transport speed to be reduced as compared with a case where the position is not the specific position.

5. The image reading device according to claim 4, wherein the processor is configured to:
in a case where the position of the recording medium in the intersecting direction is a position where a distance from a predetermined reference position to the recording medium is greater than a predetermined threshold value, set the transport speed to be reduced as compared with a case where the position of the recording medium in the intersecting direction is a position where the distance is not greater than the threshold value.

6. The image reading device according to claim 4, wherein the processor is configured to:
in a case where the position of the recording medium in the intersecting direction is not the specific position, set the transport speed to be increased.

7. The image reading device according to claim 1,
wherein the transport section transports the recording medium in one direction, and
the processor is configured to:
set the transport speed based on a degree of a movement of the recording medium transported by the transport section in a direction intersecting the one direction.

8. The image reading device according to claim 7, wherein the processor is configured to:
in a case where an amount of the movement of the recording medium in the intersecting direction is greater than a predetermined threshold value, set the transport speed to be reduced as compared with a case where the amount of the movement of the recording medium is not greater than the predetermined threshold value.

9. The image reading device according to claim 8, wherein the processor is configured to:
in a case where the amount of the movement of the recording medium in the intersecting direction is smaller than the predetermined threshold value, set the transport speed to be increased.

10. The image reading device according to claim 1, wherein the processor is configured to:
set the transport speed based on a state regarding an inclination of the recording medium transported by the transport section.

11. The image reading device according to claim 10, wherein the processor is configured to:
in a case where the inclination of the recording medium transported by the transport section is greater than a predetermined threshold value, set the transport speed to be reduced as compared with a case where the inclination is smaller than the predetermined threshold value.

12. The image reading device according to claim 11, wherein the processor is configured to:
in a case where the inclination of the recording medium transported by the transport section is smaller than the predetermined threshold value, set the transport speed to be increased.

13. The image reading device according to claim 1, wherein the processor is configured to:
set the transport speed to be changed in a case where the transport state of the recording medium transported by the transport section is in a specific state; and
set the transport speed to return to an original transport speed in a case where the transport state of the recording medium is not in the specific state.

14. The image reading device according to claim 1, wherein the processor is configured to:
set the transport speed to be changed in a case where the transport state of the recording medium transported by the transport section is in a specific state; and
notify a user that the transport speed of the recording medium is changed, in a case where the transport speed is set to be changed.

15. An image forming apparatus comprising:
an image reading device that reads an image formed on a recording medium; and
an image forming section that forms an image obtained by reading of the image reading device on the recording medium,
wherein the image reading device is configured by the image reading device according to claim 1.

16. An image forming apparatus comprising:
an image reading device that reads an image formed on a recording medium; and
an image forming section that forms an image obtained by reading of the image reading device on the recording medium,
wherein the image reading device is configured by the image reading device according to claim 2.

17. An image forming apparatus comprising:
an image reading device that reads an image formed on a recording medium; and
an image forming section that forms an image obtained by reading of the image reading device on the recording medium,
wherein the image reading device is configured by the image reading device according to claim 3.

18. An image forming apparatus comprising:
an image reading device that reads an image formed on a recording medium; and
an image forming section that forms an image obtained by reading of the image reading device on the recording medium,
wherein the image reading device is configured by the image reading device according to claim 4.

19. A non-transitory computer readable medium storing an image reading program causing a computer to execute:
a function of transporting a recording medium;
a function of reading an image formed on the transported recording medium; and
a function of setting a transport speed of the recording medium based on a transport state of the transported recording medium.

20. An image reading method comprising:
transporting a recording medium;
reading an image formed on the transported recording medium; and
setting a transport speed of the recording medium based on a transport state of the transported recording medium.
